(19) United States
(12) Patent Application Publication
(10) Pub. No.: US 2014/0247353 A1
(43) Pub. Date: Sep. 4, 2014

(54) Viewing System For Monitoring The Area Surrounding A Vehicle

(71) Applicant: Mekra Lang GmbH & Co. KG, Ergersheim (DE)

(72) Inventors: Werner Lang, Ergersheim (DE); Matthias Zink, Ohrenbach (DE)

(73) Assignee: Mekra Lang GmbH & Co. KG, Ergersheim (DE)

(21) Appl. No.: 14/193,749

(22) Filed: Feb. 28, 2014

(30) Foreign Application Priority Data
Mar. 4, 2013 (DE) 102013203642.6

(51) Int. Cl. B60R 1/06; H04N 5/225

(52) U.S. Cl. CPC B60R 1/0605; H04N 5/2252
USPC 348/148

(57) ABSTRACT

A viewing system for displaying to a driver inside a vehicle cabin an outside field surrounding the vehicle includes a deflection device, a recording device, a carrier arm and a reproduction device. The carrier arm is attached to an outer wall of the vehicle. The recording device is disposed in a first part of the carrier arm, and the deflection device is disposed in the second part of the carrier arm. The recording device is separated by a distance from the deflection device. The deflection device is disposed farther from the outer wall of the vehicle than is the recording device. The reproduction device is disposed inside the vehicle, and the deflection device is disposed outside the vehicle. The deflection device reflects an image of the outside field surrounding the vehicle onto the recording device, the recording device records the image, and the reproduction device displays the image.

### CROSS REFERENCE TO RELATED APPLICATION

This application is based on and hereby claims the benefit under 35 U.S.C. §119 from German Patent Application No. DE 102013203642.6, filed on Mar. 4, 2013, in the German Patent Office. This application is a continuation-in-part of German Patent Application No. DE 102013203642.6, the contents of which are incorporated herein by reference.

### TECHNICAL FIELD

The present invention relates generally to the field of indirect visual systems for vehicles and, more particularly, to a viewing system for displaying inside the vehicle cabin an outside field surrounding the vehicle.

### BACKGROUND

Conventional viewing systems are used for monitoring the outer field surrounding a vehicle in order to visualize that field from inside the vehicle cabin. The outer field can be viewed using indirect-view devices such as, for example, mirrors arranged inside or outside the vehicle in order to reproduce on the inside of the driver cabin the outer field surrounding the vehicle. Various legal regulations require, depending on the vehicle type and also on which areas of the field surrounding the vehicle can be directly viewed by the driver, that certain view fields around the vehicle can at all times be reproduced by the devices for indirect viewing in the vehicle cabin.

Another type of existing viewing system is disclosed by German patent application DE102011010624 A1, which describes a reproduction device, such as a screen, display or projection, that reproduces the legally prescribed view fields of a vehicle. The viewing system includes at least one recording or detecting device that records the surrounding field of the vehicle and transmits the recording to the reproduction device arranged in the vehicle cabin. The detection and recording device can be constructed, for example, as a camera that is attached to the carrier arm of an outside rear view mirror. This has the disadvantage that the camera, which is arranged in the holding arm and extends away from the vehicle, can be damaged during a collision of the holding arm with another object. In addition, the relatively sensitive electronic system of the camera is exposed to the influence of the temperature in the outer area so that the electronic system of the camera must be protected against these temperature influences in a relatively expensive manner. It is also disadvantageous that the holding arm must be constructed to be sufficiently large in order to be able to receive the camera in a protective manner. Furthermore, the camera must be protected in a relatively expensive manner against theft and outer environmental influences such as, for example, the influences of temperature and moisture.

A viewing system is sought for visualizing from inside a vehicle cabin the outer field surrounding the vehicle so that a reliable visualization is ensured with the simplest possible constructive means.

### SUMMARY

A viewing system displays an outside field surrounding a vehicle to a driver sitting inside the cabin of the vehicle. The viewing system includes a detection device that optically detects the outside field surrounding the vehicle and a reproduction device located inside the vehicle cabin that reproduces the detected field surrounding the vehicle. The detection device includes a light deflection device that optically detects the outside field surrounding the vehicle and a recording unit located a distance apart from the light deflection unit that records an image from the light deflection unit. The reproduction device displays the image.

The viewing system includes the deflection device, the recording device, the reproduction device and a carrier arm. The carrier arm is sealed against moisture and attached to an outer wall of the vehicle. The recording device is disposed in a first part of the carrier arm, and the deflection device is disposed in the second part of the carrier arm. The recording device is separated by a distance from the deflection device. The deflection device is disposed farther from the outer wall of the vehicle than is the recording device. The reproduction device is disposed inside the vehicle, and the deflection device is disposed outside the vehicle. The deflection device reflects an image of the outside field surrounding the vehicle onto the recording device. The recording device records the image, and the reproduction device displays the image. The image can be part of a video image that is displayed in real time by the reproduction device. In one embodiment, the deflection device is a mirror, the recording device is a camera, and the vehicle is a truck.

In one embodiment, the first part of the carrier arm is disposed inside the outer wall of the vehicle. In another embodiment, the first part of the carrier arm is disposed outside the outer wall of the vehicle, and the carrier arm does not pass through the outer wall of the vehicle. In yet another embodiment, the first part of the carrier arm is both inside and outside the vehicle and passes from inside the outer wall of the vehicle to outside the outer wall of the vehicle. The first part can be pivotally connected to the second part by a pivoting mechanism that allows the second part to fold in the direction of travel of the vehicle. In one embodiment, the carrier arm is disposed on a side of the vehicle, and the vehicle has no main outside side mirror. The outside field captured by the image corresponds to the view that would otherwise be visible through a conventional main outside side mirror of the vehicle.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 shows a schematically represented vehicle with a viewing system in accordance with the invention in the manner of a main outside side mirror (view field class II and III) and a wide-angle mirror (view class IV).

FIG. 2 shows a schematically represented viewing system whose recording unit and light deflection device are both arranged in a carrier arm in accordance with a first embodiment.

FIG. 3 shows a schematically represented viewing system whose recording unit and light deflection device are both arranged in a carrier arm in accordance with another embodiment.

FIG. 4 shows a schematically represented viewing system whose light deflection device is arranged in a carrier arm and whose recording unit is arranged in a vehicle cabin or other hollow space in the vehicle.

FIG. 5 shows a schematically represented viewing system whose light deflection device is arranged in a carrier arm and whose recording unit is arranged in a dry area of the vehicle.

FIG. 6 shows a schematically represented viewing system whose light deflection device is arranged in a carrier arm and whose recording unit is located in the carrier arm but inside the vehicle cabin or other hollow space of the vehicle.

FIG. 7 shows a schematically represented viewing system whose light deflection device is arranged in a carrier arm and whose recording unit is located in another receptacle inside the vehicle cabin or other hollow space of the vehicle.

FIG. 8 shows a top view of a schematically represented vehicle with a viewing system in the manner of a ramp mirror (view field class V).

FIG. 9 shows a side view of a schematically represented vehicle with a viewing system in the manner of a front mirror (view field class VI).

### DETAILED DESCRIPTION

Reference will now be made in detail to some embodiments of the invention, examples of which are illustrated in the accompanying drawings.

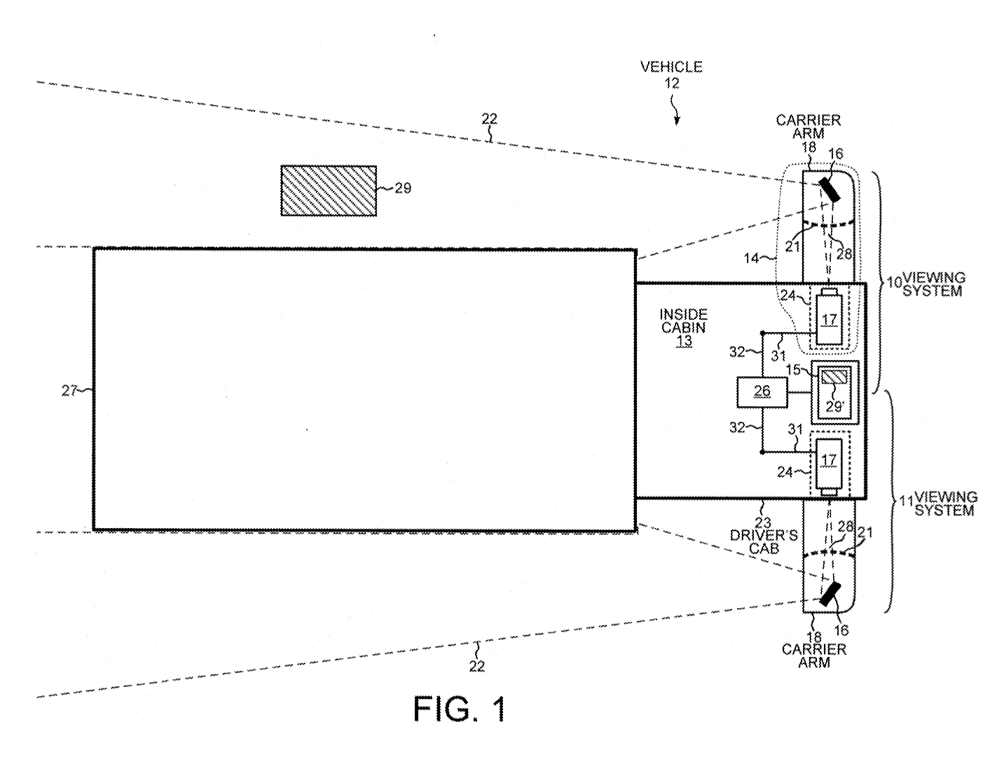

FIG. 1 shows a viewing system 10 in accordance with the invention for visualizing an outer field surrounding a vehicle 12, such as a truck, from inside the vehicle cabin 13. In the embodiment of FIG. 1, vehicle 12 has two viewing systems 10-11. Each viewing system 10-11 includes a detection device 14 that optically detects the outer field surrounding the vehicle 12 as well as at least one reproduction device 15 disposed inside the vehicle cabin 13 that reproduces the detected surrounding field of the vehicle 12. The detection device 14 includes a light deflection device 16 for the at least partial optical detection of the field surrounding the vehicle 12 and a recording unit 17 arranged at a distance from the light deflection device 16. As shown in FIG. 3, recording unit 17 is arranged in a first part 19 of a carrier arm 18 that extends outward, and the light deflection device 16 is arranged in a second part 20 of the carrier arm 18. The first part 19 and the second part 20 of the carrier arm 18 are directly or indirectly connected to one another. The recording unit 17 receives an image of the light deflection device 16 that reflects and reproduces the detected view field. The image of the detected view field is reproduced by the reproduction device 15 located inside the vehicle cabin 13.

Note that the spatial references made here are not to be understood as limiting. Therefore, “inside” does not mean “only inside” but rather “at least inside”. Likewise, the indication that “the recording unit is arranged in a first part of a carrier arm” does not mean that it is “arranged only in a first part of a carrier arm”. In particular, the recording unit 17 can extend over both the first and second parts 19-20. The same applies to the light deflection device 16. Furthermore, the description that the carrier arm 18 “extends outward” also includes the possibility that it can additionally extend inward. Moreover, the reference to “the first part and the second part are connected to one another” does not mean that the first and second parts are solely connected to one another.

The light deflection device 16 can be a light-reflecting surface, in the simplest case a reflective surface such as a mirror. The light deflection device 16 can comprise one or several light deflection elements, for example, in the form of individual mirrors. The recording unit 17, such as a camera, can optically detect and record the light reflected from the light deflection device 16. The recording unit 17 can optionally be arranged in a camera housing, such as the first part 19 of the carrier arm 18, that protects the recording unit from environmental influences.

The viewing system 10 has the advantage that the spatial separation of the light deflection unit 16 from the recording unit 17 allows the receptacle for the recording unit 17 to be placed in a relatively well-protected area of the vehicle 12. For example, it is possible to use a camera as the recording unit 17 without its camera electronics being located on the outside area such as in the holding arm of an outside mirror. In comparison to the relatively expensive recording unit 17, only a relatively inexpensive light deflection unit such as a mirror is located in the lesser protected outside area. Such a light deflection device 16 can be arranged in a traditional manner in a carrier or camera arm 18 extending away from the vehicle 12 so that the arm can be designed to be relatively simple, economical and small and with lightweight construction. In addition, it is possible to arrange the recording unit 17 in such a manner that the recording unit is protected on or in the vehicle 12 from temperature influences in the area outside the vehicle. The spatial separation of the light deflection device 16 from the recording unit 17 allows the carrier arm 18 to carry only the relatively lightweight light deflection device 16.

In order for the recording unit 17 to record the images received from the light deflection device 16, it is only necessary for the recording unit to be spatially arranged and/or aligned such that the optical detection of the images reflected by the deflection device 16 is possible. That is, there need be only an optical path between the recording unit 17 and the light deflection device 16 such as a simple void or a suitable fiber-optical light guide.

The carrier arm 18 can be designed similar to a traditional holding arm for an outside mirror of a vehicle. Instead of a conventional outside mirror of a vehicle or in addition to such a mirror, the light deflection device 16 can be arranged in the carrier arm 18 in such a manner that the outer field surrounding the vehicle 12 to can be optically detected by the light deflection device 16.

As shown in FIG. 3, the carrier arm 18 includes a first part 19 in which the recording unit 17 is arranged and a second part 20 in which the light deflection device 16 is arranged. The first part 19 is directly or indirectly connected to the second part 20, for example, by an adhesive connection, a screw connection or a rivet connection.

The light deflection device 16 can be permanently integrated into the carrier arm 18 or, alternatively, the light deflection device 16 can be adjustably arranged in the carrier arm. A permanent integration of the light deflection unit into the carrier arm 18 is easy to manufacture and can achieve an especially robust arrangement of the light deflection device 16 and a slender construction of the carrier arm 18. Alternatively, an adjustable arrangement of the light deflection device 16 on or in the carrier arm 18 achieves a flexible construction. The spatial alignment of the light deflection device 16 can be manually adjusted by the driver or automatically adjusted as a function of a particular driving situation of the vehicle 12. For example, the light deflection device 16 can be automatically adjusted when the reverse gear of the vehicle is engaged such that a viewing angle is presented that is different than during forward operation of the vehicle. In such a manner, the viewing angle presented to the driver is adapted to the current driving situation.

Due to the two-part construction of the carrier arm 18, care must be taken so that all components that are exposed to the weather are constructed to be sealed against moisture and humidity. The first part 19 and the second part 20 of the carrier arm 18 are pivotally connected to one another by a pivoting mechanism 21. The pivoting mechanism 21 allows the angle or orientation of the first part 19 to be adjusted relative to that of the second part 20. Alternatively, the first part 19 and the second part 20 of the carrier arm 18 can be connected to one another at an intended breaking position 21. Upon a collision of the carrier arm 18, damage to the recording unit 17 located in the first part 19 can be avoided when the second part 20 intentionally breaks off.

The optically detected outside field surrounding the vehicle 12 that is detected by the detection device 14 can be continuously displayed in real time to the driver of the vehicle 12 by the reproduction device 15 located inside the vehicle cabin 13. Therefore, it is possible to completely replace the outside and inside mirrors traditionally used in vehicles because the optically detected outside field surrounding the vehicle can be displayed without interruption and without a significant delay in time, that is, in real time.

In order to be able to adapt the viewing system 10 for street traffic, at least one viewing field 22 that is legally prescribed for the authorization of a vehicle for street traffic should be completely or partially optically detected and therefore visible to the driver in the vehicle cabin 13 by the spatial arrangement and/or by the spatial alignment of the light deflection device 16 and/or of the recording unit 17. A legally prescribed viewing field can be detected, for example, by two or more light deflection devices. A single light deflection device would only partially cover a legally required viewing field. In the European Union, prescribed viewing fields are defined, for example, by the EU Guidelines 1/127/EWG (or 88/321/EWG), 74/346/EWG (or 98/40/EG), 2003/97/EG (or 2005/27/EG) and 2007/38/EG and by the Regulation No. 46 of the Economic Commission of the United Nations (UN/ECE, “unified conditions for the approval of devices for indirect viewing and of motor vehicles concerning the attachment of such devices”) that must be converted by the EU member states into national laws. In the framework of this application, a viewing field 22 describes an area that is visible to the driver of a vehicle 12 from inside the vehicle cabin 13. This area can either be directly viewed by the driver of a vehicle without auxiliary means (direct view) or viewed indirectly by the driver through auxiliary means (indirect means). Six view field classes result from the above-cited EU guidelines that are each characterized by a Roman numeral I to VI. The view field class I forms the characteristic view field of an rear-view inside mirror. The view field classes II and III form the characteristic view field of the main outside side mirrors. The view field class IV forms the characteristic view field of a wide-angle mirror. The view field class V forms the characteristic view field of a ramp mirror, and the view field class VI forms the characteristic view field of a front mirror or of a front camera.

It is convenient for the driver if the optically detectable view field corresponds to the view field of a main outside side mirror, a wide-angle mirror, a ramp mirror or of a front mirror of a vehicle. Moreover, if the optically detected view field corresponds to a legally required viewing field, it is possible to supplement or replace at least one of the mirrors prescribed for the authorization of a vehicle by the viewing system of the invention.

The recording unit 17 can be arranged in a functional and/or spatial regard between the light deflection device 16 and the reproduction device 15. For example, the light deflection device 16 can be arranged at a position at a distance farther from the driver's cab 23, and the recording unit 17 can be arranged closer to the driver's cab 23 or inside the vehicle cabin 13. By locating the light deflection device 16 outside of the vehicle cabin 13, the light deflection device 16 can optically detect an especially wide view field 22, and the recording unit 17 can record the image received from the light deflection device 16. In this manner, the spatial distance between the light deflection device 16 and the recording unit 17 can be advantageously utilized.

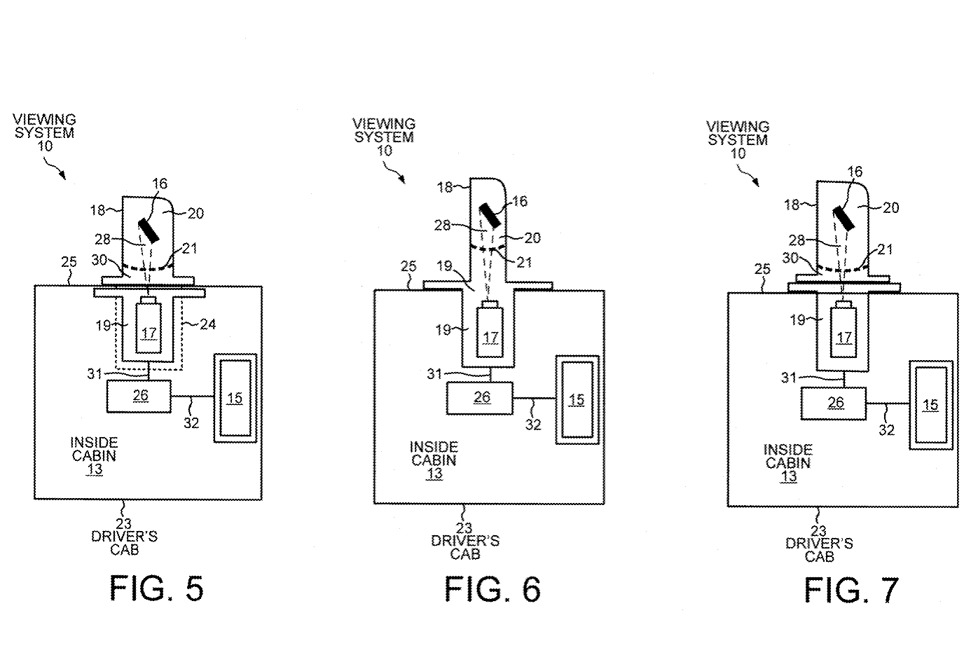

The recording unit 17 is arranged well-protected from damage and environmental influences in a dry area 24 of the vehicle 12, as shown in FIG. 5. The dry area 24 includes any hollow space of the vehicle 12 that is protected from open water, in particular from sprayed water and condensate water. In order to create an appropriate climatized environment for the recording unit 17 and its electronics, the dry area 24 can also be the vehicle cabin 13 itself, that is, the interior of the driver's cab 23. Placing the recording unit 17 in the vehicle cabin 13 offers a comparatively constant climatic environment for the electronics of the recording unit 17 that is protected from low and high outdoor temperatures. By placing the recording unit 17 in the vehicle cabin 13, the need for a separate sealed housing for the recording unit 17 can be avoided. In this manner, significant cost savings on the carrier arm 18 or the recording unit 17 itself can be achieved because they can be sealed in a less expensive manner. This measure also significantly reduces the danger of theft of the recording unit 17 because the relatively expensive recording unit 17 is housed securely inside the cabin 13.

FIG. 4 shows that the first part 19 of the carrier arm 18 can be located at least partially inside the vehicle cabin 13 so that the recording unit 17 in the first part 19 is especially well protected from external influences, such as weather influences, and from collisions between the carrier arm 18 and other objects.

Alternatively, the first part 19 and the second part 20 of the carrier arm 18 can both be arranged outside of the vehicle cabin 13, as shown in FIG. 3. This arrangement permits an especially simple construction as regards the fastening of the carrier arm 18 to the vehicle wall 25 separating the vehicle cabin 13 from the area outside the vehicle 12 because in this embodiment it is not necessary for the carrier arm 18 to pass through the vehicle wall 25. Only a data line and an electrical line must pass through the vehicle wall 25 to the reproduction device 15 or to a calculating unit 26 for information processing. It is advantageous in such an arrangement for the recording unit 17 to be positioned as close as possible to the vehicle wall 25, as shown in FIG. 3. In this case, the calculating unit 26 is constructed separately from the recording unit 17. Alternatively, the recording unit 17 and the calculating unit 26 form a common integrated functional unit that can even include the reproduction unit 15.

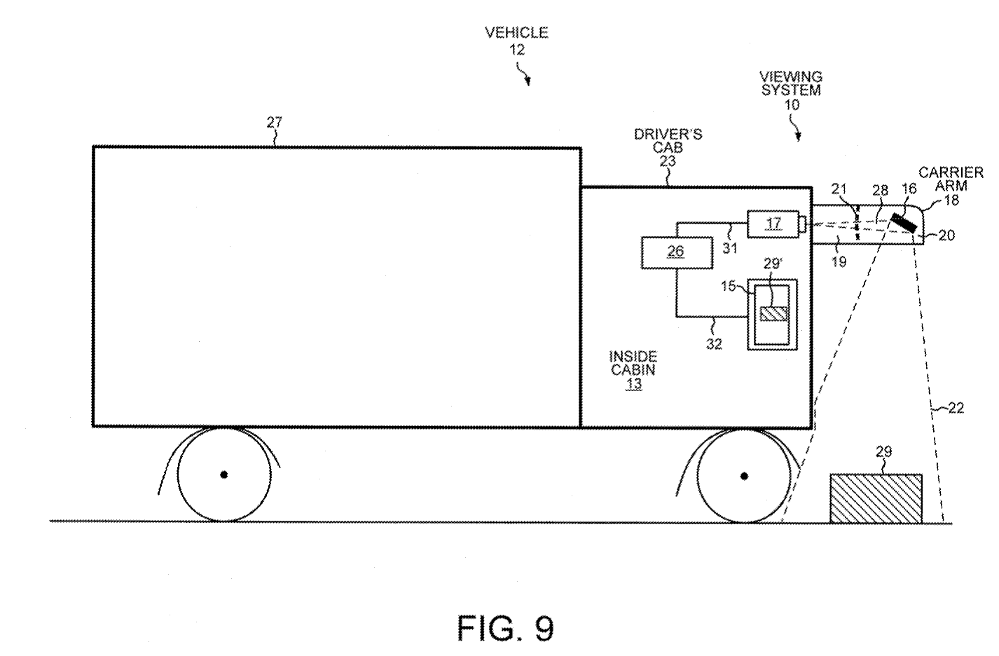

FIG. 9 shows an embodiment in which a panoramic view for the driver is achieved by placing the recording unit 17 and the carrier arm 18 in or near the roof area of the vehicle 12. In general, an arrangement on the vehicle in a non-door area with a hollow area, for example, a fender area, is advantageous because then the running through of the electrical and optionally optical lines through the vehicle wall 25 is simplified on account of the lack of hinges and articulations.

The outside field 22 surrounding the vehicle 12 is realistically displayed to the driver in accurate detail and without distortion by shaping the light deflection device 16 as a freeform surface whose geometry is convex, concave or a plane. For example, the light deflection device 16 can be shaped in a non-spherical manner. This reduces deformation and distortion of the displayed image and reduces the amount of image correction that must be performed by the calculating unit 26.

The light deflection device 16 can also be heated or housed in a heated area, in a manner similar to that performed for traditional outside mirrors. As with traditional mirrors, ice or condensation water that adversely affect the sight and function of the light deflection device 16 can be removed in this manner.

FIG. 1 shows a top view of the vehicle 12 with two viewing systems 10-11. In this exemplary embodiment, the vehicle 12 is a commercial vehicle in the form of a truck. The vehicle 12 includes the driver's cab 23 and a rig or trailer 27 provided for the transportation of goods and arranged in the direction of travel behind the driver's cab 23.

The viewing systems 10-11 display to the driver of vehicle 12 an outside field surrounding the vehicle. Viewing system 10 includes the reproduction unit 15 disposed in the vehicle cabin 13, that is, inside the driver's cab 23. In this embodiment, the reproduction unit 15 is a monitor or display that is arranged in such a manner that it can be viewed or read in an ergonomically favorable manner by the driver of the vehicle 12. Furthermore, the viewing system 10 includes the light deflection device 16 that is located outside of the vehicle cabin 13 and is spatially aligned in such a manner that the view field 22 can be optically detected. In this embodiment, the light deflection device 16 is a reflective surface in the form of a mirror. Furthermore, the viewing system 10 includes the recording unit 17 in the form of a video camera that is aligned in such a manner that the view field 22 that is reflected as an image by the light deflection device 16 can be recorded and filmed by the recording unit 17. In this manner, it is ensured that an unobstructed optical path 28 is present between the light deflection device 16 and the recording unit 17 that allows the recording unit 17 to record the image received from the light deflection device 16. In this exemplary embodiment, the optical path 28 is formed by a mere void of the space separating the light deflection device 16 and the recording unit 17.

For a reproduction of the view field 22 detected and reflected by the light deflection device 16 and recorded by the recording unit 17, the recording unit 17 is functionally connected to the reproduction unit 15 by electrical lines 31, 32. FIG. 1 shows that an optional calculating unit 26 can be arranged between the recording unit 17 and the reproduction unit 15 or can be functionally integrated into the reproduction unit 15.

The view field 22 that is detected by the light deflection device 16 extends from the light deflection device 16 laterally along the driver's cab 23 and the rig 27 in the longitudinal direction of the vehicle 12 in order to display the outer vehicle in the manner of a main outside side mirror (view field class II and III). For example, an object 29 present in the view field 22, such as another motor vehicle or a bicycle rider, can be optically detected and displayed to the driver of the vehicle 12 by the reproduction unit 15 as an image 29′ in the vehicle cabin 13. In order to be able to supplement or even completely replace a main outside side mirror of the vehicle 12, the viewing system 10 and its individual components are arranged so as to represent the view field 22 continuously and in real time, that is, without a significant or perceptible latency time in the reproduction unit 15.

FIG. 1 shows that the light deflection device 16 of the viewing system 10 is integrated into a carrier arm 18 that extends laterally away from the cab 23 in the transverse direction of travel. Thus, the light deflection device 16 is arranged outside of the vehicle cabin 13. On the other hand, the recording unit 17 is located inside the vehicle cabin 13 and spatially apart from the light deflection device 16. The recording unit 17 is arranged or housed in the dry area 24 (indicated by the dashed line in FIG. 1) of the vehicle 12 in order to avoid an expensive sealing of the light deflection device 16 in the carrier arm 18. Vehicle 12 includes a viewing system 10, 11 on each of its sides, that is, on the right and the left of the longitudinal axis of the vehicle, in order to supplement or completely replace both traditional main side mirrors of the vehicle 12.

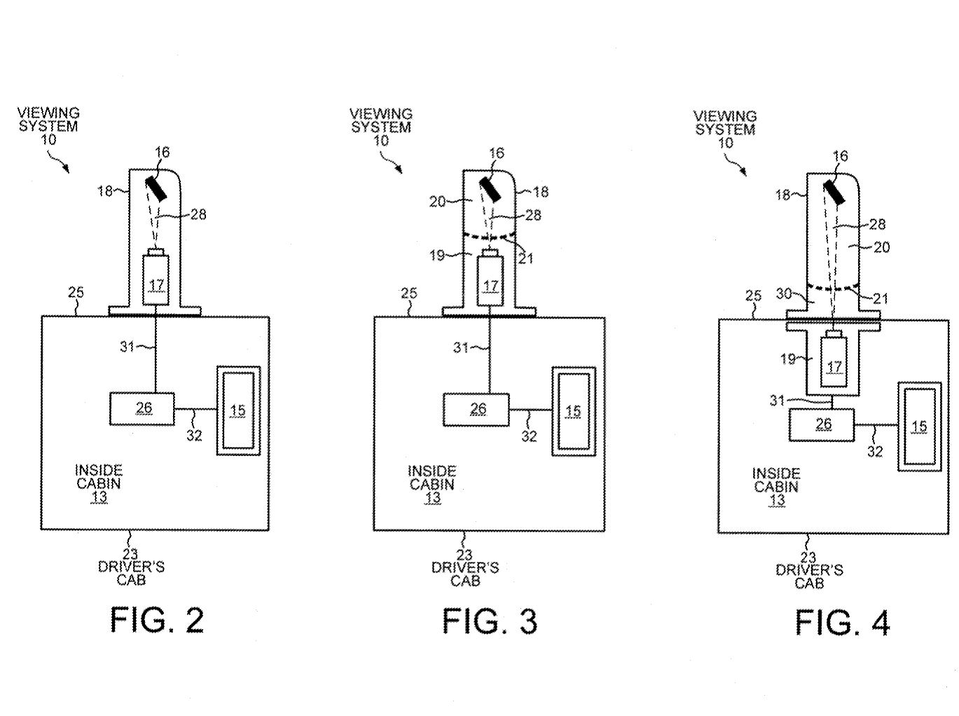

FIG. 2 shows a first embodiment of the viewing system 10 with a first possible arrangement of the light deflection device 16, the recording unit 17, and the carrier arm 18. The light deflection device 16 and the recording unit 17 are both arranged outside of the vehicle cabin 13 and at a distance apart from one another. The light deflection device 16 is located at a position that is farther away from the vehicle cabin 13 than is the recording unit 17. In addition, the carrier arm 18 is constructed substantially in one piece in this constructively simple solution. In order to protect the relatively sensitive camera electronics of the recording unit 17, the inside of the carrier arm 18 is protected against penetration by environmental influences, such as dirt and moisture, by a seal in a sufficiently high sealing class.

FIG. 3 shows an alternative embodiment of the viewing system 10 in which the carrier arm 18 is constructed in two parts. The first part 19 of the carrier arm 18 has the form of a camera housing for receiving and holding the recording unit 17. The second part 20 is designed to receive and hold the light deflection device 16. In order to protect the relatively sensitive camera electronics of the recording unit 17, the first part 19 of the carrier arm 18 is protected against the field surrounding the vehicle and/or against the second part 20 from the penetration of environmental influences, such as dirt or moisture, by a seal in a sufficiently high sealing class.

The first part 19 and the second part 20 are pivotally connected to one another in FIG. 3 by a pivoting mechanism 21. Pivoting mechanism 21 is appropriate if the ability to adjust the light deflection device 16 in carrier arm 18 or to fold away the second part 20 upon a collision of the carrier arm 18 with a hindrance is desired.

FIG. 4 shows an alternative embodiment of the viewing system 10 in which the first part 19 of the carrier arm 18 is located inside the vehicle cabin 13. In this manner, the recording unit 17 can be protected in a constructively simple manner from damage by collisions or other mechanical influences. In addition, by shifting the recording unit 17 into the vehicle cabin 13, the relatively delicate camera electronics are protected from influences of temperature and other weather conditions on the outside area of the vehicle 12. The carrier arm 18 can have a lighter construction because the recording unit 17 does not have to be completely carried by the carrier arm 18. A holding arm 30 is disposed outside the outer vehicle wall 25 between the first part 19 and the second part 20.

FIG. 5 shows another embodiment of the viewing system 10 in which the recording unit 17 is well protected from environmental influences in a dry area 24 of the vehicle 12. The dry area 24 is well protected from the penetration of humidity and moisture and from the entry of environmental influences such as contaminants. The carrier arm 18 includes the second part 20 that houses the light deflection device 16 and is fastened to the outside wall 25 of the vehicle 12 by the holding arm 30. The optical path 28 extends from the recording unit 17 located in the dry area 24 through the outer vehicle wall 25 to the light deflection device 16 located outside the vehicle cabin 13. This embodiment of the viewing system 10 makes it possible to construct the carrier arm 18 as simply as possible with an especially light, slender and/or long construction without any expensive seal of a high sealing class.

FIG. 6 shows an alternative embodiment of the viewing system 10 in which the first part 19 of the carrier arm 18 is located inside the vehicle cabin 13 and also extends out away from the outer vehicle wall 25. The recording unit 17 is located in the first part 19 in a hollow space of the vehicle 12 or in the vehicle cabin 13. The light deflection device 16 is located in the second part 20 of the carrier arm 18. The first part 19 is constructed in the shape of a camera housing that extends outward past the outer vehicle wall 25 and is sealed so well from the environment that the recording unit 17 is well-protected against environmental influences.

FIG. 7 shows the viewing system 10 of another embodiment in which the light deflection device 16 is located in the carrier arm 18 and the recording unit 17 is located in the vehicle cabin 13 or in a hollow space of the vehicle 12. The first part 19 is constructed in the shape of camera housing and has a flange that fits on the outer vehicle wall 25. A holding arm 30 is disposed between the first part 19 and the second part 20 in order to achieve an especially robust embodiment of the viewing system 10. A pivoting mechanism 21 allows the angle of the second part 20 to be adjusted relative to that of the holding arm 30.

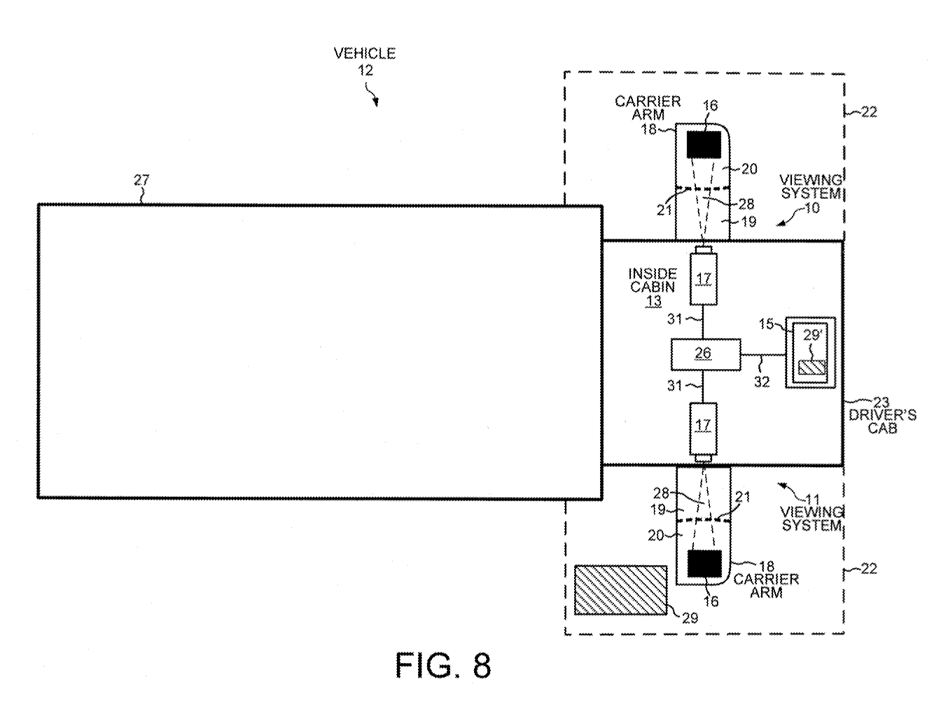

FIG. 8 is a schematic top view of the vehicle 12 and the viewing system 10 illustrating another use of the viewing system 10. In this use, the viewing system 10 is designed in the manner of a ramp mirror that displays view field class V as defined in the EU Guidelines 74/346/EWG and 2003/97/EG and in U.N. Economic Commission UN/ECE Regulation No. 46. The principal construction of the viewing system 10 corresponds to the description above in that system 10 includes a light deflection device 16 located outside of the vehicle cabin 13 and a recording unit 17 and a reproduction unit 15 located inside the vehicle cabin 13. The recording unit 17 is located a distance apart from the light deflection device 16. In this arrangement, the viewing system 10 makes it possible to display an object 29 located near the side of the vehicle 12 and at the height of the driver's cab 23. For example, object 29 in FIG. 6 is located on the right side of the vehicle and is displayed by the reproduction unit 15 as image 29′.

FIG. 9 is a schematic side view of the vehicle 12 showing the viewing system 10 designed as a front mirror for displaying the view field class VI as defined in EU guidelines 74/346/EWG and 2003/97/EG. In this arrangement as well, the viewing system 10 includes a light deflection device 16 located outside of the vehicle cabin 13 and a recording unit 17 and a reproduction unit 15 located inside the vehicle cabin 13. The recording unit 17 is arranged a distance apart from the light deflection device 16. The viewing system 10 of FIG. 9 displays an object 29 that is present directly in front of the vehicle 12. An object 29 present in front of the vehicle 12 is reproduced as image 29′ and is displayed by the reproduction unit 15 in the vehicle cabin 13.

Starting from the embodiments shown, the viewing system 10 in accordance with the invention can be modified in many respects. For example, it is conceivable that the vehicle 12 has several viewing systems 10-11 in order to display to the driver inside the vehicle cabin 13 several or even all of the view field classes I to VI. The reproduction unit 15 can either display all view field classes I to VI at the same time continuously and in real time or several individual reproduction units 15 can be present, each one displaying one or several of the view field classes I to VI. In addition, the light deflection unit 16 can also comprise several light deflection elements that can be detected by one recording unit 17.

Furthermore, it is possible to provide the carrier arm 18 with an intended breaking position 21 so that upon a collision of the carrier arm 18 a part of the carrier arm 18 breaks off as intended in order to avoid damage to the driver's cab 23. This intended breaking position 21 can be provided either alternatively to the pivoting mechanism 21 in FIG. 4 or in addition to it. Furthermore, it is possible to replace the pivoting mechanism 21 by a simple and economical adhesive, screw or rivet connection in order to make available in this manner an especially economical embodiment of the carrier arm 18.

Furthermore, it is possible to integrate other vehicle functions into the carrier arm 18 such as a distance sensor, an antenna for receiving satellite signals or radio signals, an indicator of the direction of travel, or a dead angle sensor.

As explained above, the calculating unit 26 shown in FIGS. 1-7 as a separate component can also be integrated into the reproduction unit 15 or into the recording unit 17. Instead of the calculating unit 26 correcting a deformation or distortion of the image 29′, the image correction can also be achieved by the shape of the light deflection device 16. The optical path 28 can be constructed either in the form of a void or free view field between the light deflection device 16 and the recording unit 17 or, as an alternative, by a suitable optical conductor or fiber optical light guide.

### LIST OF REFERENCE NUMERALS

10 viewing system
11 viewing system
12 vehicle
13 driver's cabin
14 detection device
15 reproduction device
16 deflection device
17 recording unit
18 carrier arm
19 first part of carrier arm
20 second part of carrier arm
21 pivoting mechanism or intended breaking location
22 viewing field
23 driver's cab
24 dry area of the vehicle 12
25 outer vehicle wall
26 calculating unit
27 rig or trailer
28 optical path
29 object in viewing field
29′ displayed image of object 29
30 holding arm
31 electrical line
32 electrical line

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-11. (canceled)

12. A system comprising:
a carrier arm with a first part and a second part, wherein the carrier arm is attached to an outer wall of a vehicle;
a recording device disposed in the first part of the carrier arm;
a deflection device disposed in the second part of the carrier arm, wherein the deflection device is disposed farther from the outer wall than is the recording device, and wherein the recording device is separated by a distance from the deflection device; and
a reproduction device disposed inside the vehicle, wherein the deflection device is disposed outside the vehicle and reflects an image of an outside field surrounding the vehicle onto the recording device, wherein the recording device records the image, and wherein the reproduction device displays the image.

13. The system of claim 12, wherein the first part of the carrier arm is disposed inside the outer wall of the vehicle.

14. The system of claim 12, wherein the first part of the carrier arm is disposed outside the outer wall of the vehicle, and the carrier arm does not pass through the outer wall of the vehicle.

15. The system of claim 12, wherein the first part of the carrier arm passes from inside the outer wall of the vehicle to outside the outer wall of the vehicle.

16. The system of claim 12, wherein the image is reflected from the deflection device through a void to the recording device.

17. The system of claim 12, wherein the first part is pivotally connected to the second part by a pivoting mechanism that allows the second part to fold in the direction of travel of the vehicle.

18. The system of claim 12, wherein the deflection device is a mirror.

19. The system of claim 12, wherein the carrier arm is disposed on a side of the vehicle, and wherein the vehicle has no main outside side mirror.

20. The system of claim 12, wherein the outside field captured by the image corresponds to a view captured by a main outside side mirror of the vehicle.

21. The system of claim 12, wherein the carrier arm is sealed against moisture.

22. The system of claim 12, wherein the image is part of a video image that is displayed in real time by the reproduction device.

23. A system comprising:
a carrier arm attached to an outer wall of a vehicle;
a recording device disposed in the carrier arm;
a deflection device disposed in the carrier arm, wherein the deflection device is disposed farther from the outer wall than is the recording device, wherein the recording device is separated by a distance from the deflection device, and wherein there is an unobstructed optical path between the deflection device and the recording device; and
a reproduction device disposed inside the vehicle, wherein the deflection device is disposed outside the vehicle and reflects an image of an outside field surrounding the vehicle onto the recording device, wherein the recording device records the image, and wherein the reproduction device displays the image.

24. The system of claim 23, wherein the carrier arm is disposed partially inside the vehicle.

25. The system of claim 23, wherein the recording device is disposed inside the outer wall of the vehicle, and wherein the carrier arm passes through the outer wall of the vehicle.

26. The system of claim 23, wherein the recording device is disposed outside the outer wall of the vehicle, and wherein the carrier arm does not pass through the outer wall of the vehicle.

27. The system of claim 23, wherein the carrier arm is attached to the outer wall of the vehicle near a roof of the vehicle.

28. The system of claim 23, wherein the carrier arm is disposed on a side of the vehicle, and wherein the vehicle has no main outside side mirror.

29. The system of claim 23, wherein the vehicle is a truck.

30. The system of claim 23, wherein the carrier arm is sealed against moisture.

31. The system of claim 23, wherein the image is part of a video image that is displayed in real time by the reproduction device.

32. A vehicle comprising:
a carrier arm attached to a wall of the vehicle;
a camera disposed inside the carrier arm;
a mirror disposed in the carrier arm, wherein the mirror is disposed farther from the wall of the vehicle than is the camera, wherein the camera is separated by a distance from the mirror, and wherein there is an unobstructed optical path between the mirror and the camera; and
a reproduction device disposed inside the wall of the vehicle, wherein the mirror is disposed outside the wall of the vehicle and reflects an image of an outside field surrounding the vehicle towards the camera, wherein the camera records the image, and wherein the reproduction device displays the image.
